(19) United States
(12) Patent Application Publication
(10) Pub. No.: US 2006/0077857 A1
(43) Pub. Date: Apr. 13, 2006

(54) Optical information recording apparatus and method for recording optical information

(75) Inventors: Akiko Hirao, Chiba (JP); Kazuki Matsumoto, Kanagawa (JP); Rumiko Hayase, Kanagawa (JP); Takayuki Tsukamoto, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/227,271

(22) Filed: Sep. 16, 2005

(30) Foreign Application Priority Data
Sep. 24, 2004 (JP) P2004-278273

(51) Int. Cl. G11B 7/135

(52) U.S. Cl. 369/112.01; 369/112.1

(57) ABSTRACT

The optical information recording apparatus includes a laser light source for radiating a light beam, a spatial light modulator disposed on an optical path of the light beam, a power density control mechanism disposed on the optical path, an interference fringe formation mechanism. The spatial light modulator has pixels arranged in a two-dimensional array at which a central section of the light beam is radiated. The spatial light modulator spatially modulates the light beam. The power density control mechanism is set such that the transmittance with respect to the light beam at a portion where the central section is radiated is lower than that at which a peripheral section of the light beam is radiated. The interference fringe formation mechanism forms interference fringes from the central section and the peripheral section on the optical information recording medium disposed downstream on the optical path.

### CROSS REFERENCE TO RELATED APPLICATIONS

This application is based upon and claims the benefit of priority from the prior Japanese Patent application No. 2004-278276, filed on Sep. 24, 2004; the entire contents of which is incorporated by herein by reference.

### BACKGROUND OF THE INVENTION

1. Field of the Invetion

The present invention relates to an optical information recording apparatus making use of a holography and to a method for recording optical information.

2. Description of the Related Art

As a result of extensive studies, the present inventors have discovered the following problem.

When a light intensity (an integrated value of power density with respect to area) of the information beam region and that of the reference beam region are of the same value, visibility of the above-mentioned single-light-beam type optical information recording apparatus attains its maximum value of 1. Meanwhile, “fringe visibility” is an index indicating contrast of intensities in interference fringes formed on an optical information recording medium; a value close to 1 indicates high contrast in the interference fringes.

In relation to the above, in a case where the cross-sectional profile of the light beam is of uniform power density, when the information beam region and the reference beam region have the same area, the visibility attains its maximum value. However, generally, the power density on the cross-sectional profile of the light beam has a Gaussian distribution, and the power density is high in the central section as compared with that in the peripheral section.

Accordingly, to maximize visibility, an area of the information beam region located in the central section must be rendered smaller than that of the reference beam region located in the peripheral section. However, when the area of the information beam region is reduced, information capacity per page (i.e., the amount of information that can be recorded on the optical information recording medium in a single radiation operation) is decreased, leading to a drop in information capacity and a drop in transfer rate.

An optical information recording apparatus making use of a hologram is an optical recording technique for realizing a larger capacity and higher transfer rate as compared with other information recording apparatus, such as those based on a magneto-optic method and those based on a photorefractive method, and has been actively developed.

Among optical information recording apparatus, a collinear method, in which a recording beam and a reference beam are coaxially incident on an optical information recording medium, is preferable from a viewpoint of reduction in size, ease in mechanical control, and other factors in relation to an optical system.

Furthermore, there has recently been proposed an optical data recording apparatus of a single-light-beam type wherein a peripheral section of a cross-sectional profile of a light beam to be radiated on an optical recording medium is taken as a reference beam region, and a central section of the same is taken as an information beam region (see Hideyuki Horimai and Kun Li, “A novel collinear optical setup for holographic data storage system”, Technical Digest of Optical Data Storage Topical Meeting 2004, PP. 258-260, (2004)). The optical information recording apparatus increases allowable error of a wavelength, and the like.

### SUMMARY OF THE INVENTION

It is an advantage of an aspect of the invention to provide an optical information recording apparatus which can maintain visibility of interference fringes recorded on an optical information recording medium and which can increase information capacity per page, as well as a method therefor.

According to one aspect of the invention, a laser light source for radiating a light beam, a spatial light modulator disposed on an optical path of the light beam, a power density control mechanism disposed on the optical path of the light beam, an interference fringe formation mechanism, and a photodetector. The spatial light modulator has pixels arranged in a two-dimensional array at a portion where the central section of the light beam is radiated and which can spatially modulate the light beam. The power density control mechanism is set such that transmittance with respect to the light beam at a portion where the central section of the light beam is radiated is lower than that at a portion where the peripheral section of the light beam is radiated. The interference fringe formation mechanism can form interference fringes from the central section and the peripheral section of the light beam on the optical information recording medium disposed downstream on the optical path of the light beam. The photodetector is disposed at the terminal end on optical path of the light beam.

According to another aspect of the invention, a laser light source for radiating a light beam, a spatial light modulator disposed on an optical path of the light beam, a power density control mechanism disposed on the optical path of the light beam, an interference fringe formation mechanism, and a photodetector. The spatial light modulator has pixels arranged in a two-dimensional array at a portion where the central section of the light beam is radiated and which can spatially modulate the light beam. The power density control mechanism is set such that the reflectance with respect to the light beam at a portion where the central section of the light beam is radiated is lower than that at a portion where the peripheral section of the light beam is radiated. The interference fringe formation mechanism can form interference fringes from the central section and the peripheral section of the light beam on the optical information recording medium disposed downstream on the optical path of the light beam. The photodetector is disposed at the terminal end on the optical path of the light beam.

According to another aspect of the invention, a process of spatially modulating a central section of a light beam to cause an information beam to contain data to be recorded; a process of further reducing a power density of the central section of the light beam; and a subsequent process of forming interference fringes from the peripheral section and the central section of the beam on an optical information recording medium.

According to another aspect of the invention, an optical information recording apparatus which can maintain visibility of interference fringes recorded on an optical information recording medium and which can increase an information capacity per page, and a method for recording optical information.

### BRIEF DESCRIPTION OF THE DRAWINGS

FIG. 1 is a schematic view for explaining a method for recording optical information according to a first embodiment;

FIG. 2A is a schematic view for explaining an example of an optical information recording apparatus of a second embodiment;

FIG. 2B is overall view of the optical information recording apparatus of the second embodiment;

FIG. 3 is an schematic view for explaining another example of the optical information recording apparatus of the second embodiment; and

FIG. 4 is a schematic view for explaining a drive mechanism, control mechanism, and the like of the optical information recording apparatus of the second embodiment.

### DESCRIPTION OF THE EMBODIMENTS

Hereinafter, embodiments of the invention will be described by reference to the drawings. In the following descriptions, identical elements are denoted by the same reference numerals, and repeated descriptions are omitted. Each drawing is a schematic diagram for promotion of understanding, which may include shapes, sizes, and ratios that differ from those of the actual apparatus; however, such shapes, sizes, and ratios can be changed in consideration of the following descriptions and the known art.

The embodiments of the present invention relates to an apparatus records/reproduces as interference pattern information which may be included by modulating at least one between an intensity of the light beam, polarization and a phase with respect to one part of the light beam, and the other part of the light beam is used as “reference beam section”. The information can be included in any section of the light beam, but a center of the light beam may include the information, since a peripheral section of the light beam is often modulated when the light beam goes through optical parts such as lens. Thus, the center of the light beam can be modulated as “information beam”, and the peripheral section of the light beam can be modulated as “reference beam.”

### First Embodiment

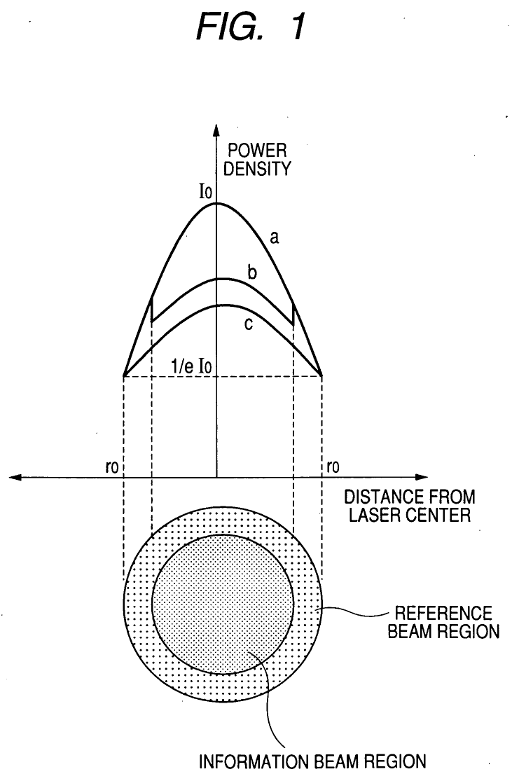

A method for recording optical information according to a first embodiment will be described by reference to FIG. 1.

The method for recording optical information according to the first embodiment is characterized by including a process of spatially modulating a central section of a light beam to thus cause an information beam to contain data to be recorded; a process of further reducing a power density in the central section of the light beam; and a subsequent process of forming interference fringes from the peripheral section and the central section of the light beam on an optical information recording medium.

When the visibility is uniform on the cross-sectional profile of the light beam, the following equation (1) holds among a mean value of the power density of the information beam region, an area of the same, a mean value of the power density of the reference beam region, and an area of the same.
constant k=(mean value of power density in the information beam region)/(mean value of power density in the reference beam region)×(area of the information beam region)/(area of the reference beam region) Equation (1)

Therefore, according to the first embodiment, by means of reducing the power density of the information beam region in relation to that of the reference beam region, the area of the information beam region can be made larger in relation to the area of the reference beam region. Consequently, since a diameter of the light beam is constant, the area of the information beam region is increased, thereby increasing information capacity per page.

Detailed description will be provided by reference to FIG. 1 hereinbelow.

FIG. 1 is a schematic view showing the power density on the cross-sectional profile of a light beam in relation to the method for recording optical information according to the first embodiment.

As shown in the bottom of FIG. 1, on the cross-sectional profile of a light beam to be radiated on an optical information recording medium, the central section is assigned to an information beam region, and the peripheral section is assigned to the reference beam region. The information beam region has a plurality of light beams arrayed in two-dimensional gratings, and the respective light beams differ in power density. In the reference beam region, light flux produced by differences in power density forms a random pattern.

At the top of FIG. 1, the power density on the cross-sectional profile of the light beam is shown.

Assuming that the light beam has the cross-sectional profile of circular shape, the power density in the center of the light beam radiated from a laser source is denoted as I₀, and the distance from the center of the light beam is denoted as “r.” In addition, temporarily, a position “r” where the power density attains I₀×(1/e) is assumed to be “r₀” and “r₀” is usually defined as a radius of the light beam.

A region where “r/r₀” (the distance “r” normalized by “r₀”) is not more than 0.6 may be defined as an “information beam region”. A region where “r/r₀” (the distance “r” normalized by “r₀”) is equal to or not less than 0.6 may be defined as “reference beam region”. At this time, a relation between the average of the power density of both the information beam region and the reference beam region and the area of both the information beam region and the reference beam region may satisfy the above-equation (1).

The region where “r/r₀” (the distance “r” normalized by “r₀”) is not more than 0.8 may be defined as an “information beam region”. The region where “r/r₀” (the distance “r” normalized by “r₀”) is equal to or not less than 0.8 may be defined as “reference beam region”. At this time, a relation between the average of the power density of both the information beam region and the reference beam region and the area of both the information beam region and the reference beam region may satisfy the above-equation (1) The larger area of the information beam region is, more information can be included.

Further more, the region where “r/r₀” (the distance “r” normalized by “r₀”) is not more than 0.9 may be defined as an “information beam region”. The region where “r/r₀” (the distance “r” normalized by “r₀”) is equal to or not less than 0.9 may be defined as “reference beam region”. The larger the area of the information beam region is, the more information can be included. At this time, the relation between the average of the power density of both the information beam region and the reference beam region and the are of both the information beam region and the reference beam region may satisfy the above-equation (1).

Meanwhile, for convenience of explanation, the drawing shows the mean power density at a distance from a laser center.

A plot “a” shows a power density on the cross-sectional profile the light beam radiated from the laser light source, and shows a Gaussian distribution. Plots “b” and “c” show power densities on the cross-sectional profile the light beam radiated on the optical information recording medium.

The plot “b” shows a case where only the power density in the information beam region is caused to decrease in relation to the plot “a,” and that in the reference beam region is maintained unchanged. The plot “c” shows a case where the power densities in both the information beam region and the reference beam region are reduced as compared with the plot “a”; however, the power density in the information beam region is reduced to a greater extent than that in the reference beam region. Meanwhile, the plots “b” and “c” are assumed to have moderate Gaussian distributions as compared with the plot “a”; however, a plot of power density on the cross-sectional profile of the light beam on the optical information recording medium may assume the form of another curve or of a straight line.

Reduction ratio of the power density in the peripheral section of the light beam is preferably lower than that in the central section of the light beam, by a ratio falling within a range of 10 to 60%. When the reduction ratio is greater than or equal to 10%, an increase in information capacity per page can be secured; and when the same is smaller than or equal to 60%, prolonging of recording time per page, which is a problem arising from a reduction in power density, can be suppressed. Meanwhile, for comparison of reduction ratios in power density, a mean value of the power density in the central section and that in the peripheral section are employed.

In particular, when a laser light source whose output power falls within a range of about 5 mW to 50 mW, such as a semiconductor laser, is employed, the reduction ratio of the power density in the peripheral section of the light beam is preferably lower than that in the central section of the light beam, by a ratio falling within a range of 10 to 50%. When the reduction ratio is 10% or greater, an increase in information capacity per page can be secured; and when the same is 50% or smaller, prolonging of recording time per page arising from a reduction in power density can be suppressed.

In addition, it is not preferred to actively decrease power density in the peripheral section of the light beam with a view toward securing a difference in power density between the central section and the peripheral section of the light beam. Reduction ratio of the power density in the peripheral section of the light beam is preferably 5% or smaller, more preferably 1% or smaller.

### Second Embodiment

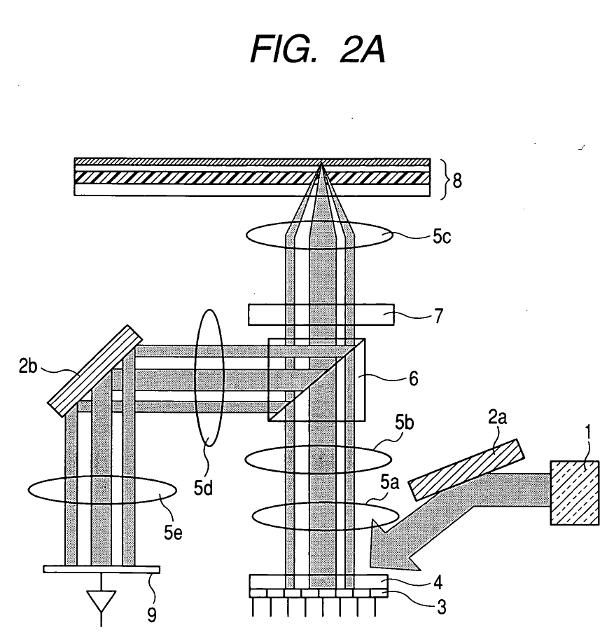

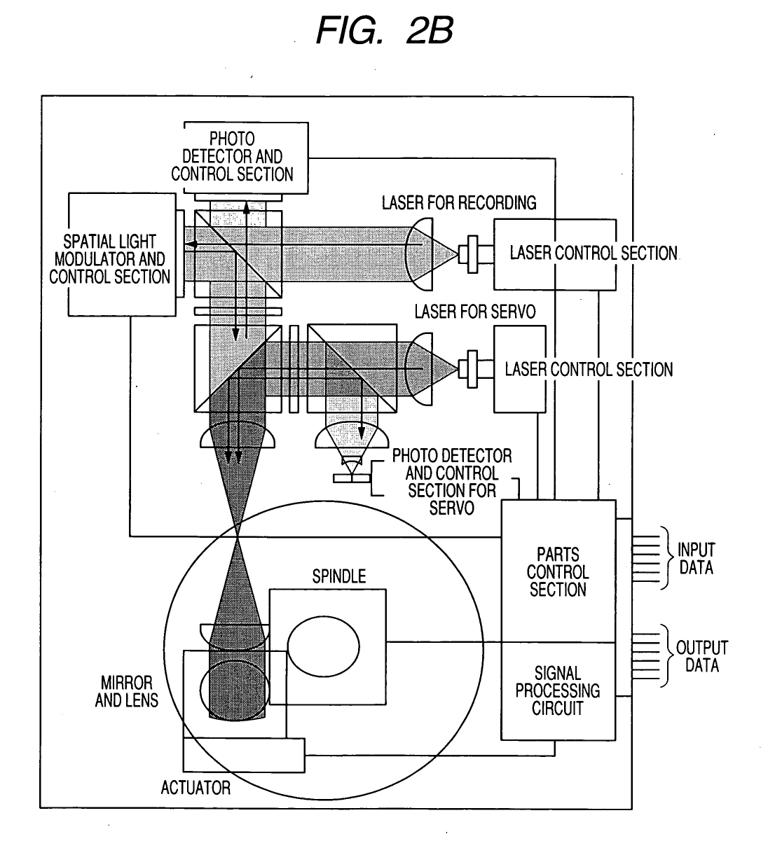

FIG. 2A is a schematic view for explaining an example of an optical information recording apparatus of a second embodiment. FIG. 2B is overall view of the optical information recording apparatus of the second embodiment.

First, operations where information is recorded will be described. As shown in FIG. 2, a light beam radiated from a laser light source 1 is reflected by a mirror 2a, and reaches a power density control mechanism 4. Meanwhile, for convenience of explanation, a light beam in this case is not illustrated; however, the light beam is expanded in diameter by means of a beam expander, and also is collimated into a collimated light beam. The power density control mechanism 4 has a mechanism of further reducing the power density in the information beam region in relation to the change in the power density in the reference beam region. Thereafter, the light beam reaches a spatial light modulator 3. The spatial light modulator 3 is of a reflectance type. The light beam is spatially modulated by the spatial light modulator 3, whereby a central section in the cross-sectional profile of the light beam is employed as an information beam region, and a peripheral section is employed as a reference beam region. In relation to the above, the information beam region is caused to contain two kinds of conditions constituted of light pixels and dark pixels, in accordance with information to be recorded. Thereafter, the light beam passes through the power density control mechanism 4 again.

Next, the light beam sequentially passes through two lenses 5a, 5b for adjusting focal points, a polarization beam splitter 6, and a quarter-wave plate 7. Thereafter, the light beam passes through an imaging lens 5c, and reaches an optical information recording medium 8. On the optical information recording medium 8, the reference beam and the information beam are radiated to thus form interference fringes, and a refractive index difference, transmittance, or the like, of the interference fringes is recorded. Here, the imaging lens 5c and the quarter-wave plate 7 constitute the interference fringe formation mechanism. The light reflected by a reflection layer of the optical information recording medium 8 again passes through the imaging lens 5c and the quarter-wave plate 7, and is reflected by the polarization beam splitter 6. Thereafter, the light beam is reflected by a mirror 2b, and passes through two lenses 5d, 5e for adjusting a focal point, and reaches a photodetector 9.

When information is reproduced, an information beam is not reflected by the spatial light modulator 3; only a reference beam is reflected thereby. Accordingly, only the reference beam is radiated on the optical information recording medium 8. Thereafter, the recording light containing information recorded in the optical information recording medium 8 reaches the photodetector 9, thereby enabling reading of the information recorded in the optical information recording medium 8.

Hereinbelow, detailed configurations of the power density control mechanism, the spatial light modulator, the interference fringe formation mechanism, the photodetector, the laser light source, and other elements will be described.

(1) Power Density Control Mechanism

The power density control mechanism is disposed on the optical path of the light beam, and has a function of further reducing the power density in the information beam region in relation to the change in power density in the reference beam region.

Types of the power density control mechanism include a transmittance type and a reflectance type. The transmittance-type adjusts the power density by adjusting a transmittance with respect to the light beam; and the reflectance type adjusts the same by adjusting a reflectance with respect to the light beam. More specifically, the transmittance-type power density control mechanism is characterized in that transmittance with respect to the light beam at a portion where the central section of the light beam is radiated is set lower than that at a portion where the peripheral section of the light beam is radiated. In contrast, the reflectance-type power density control mechanism is characterized in that reflectance with respect to the light beam at a portion where the central section of the light beam is radiated is set lower than that at a portion where the peripheral section of the light beam is radiated.

According to the second embodiment, by means of further reducing the power density in the information beam region in relation to the change in power density in the reference beam region, the area of the information beam region is expanded, thereby enabling an increase in information capacity per page.

Hereinbelow, the transmittance-type power density control mechanism will be described.

The power density control mechanism is preferably such that a random pattern is formed by differences in transmittance of the light beam at a portion where the peripheral section of the light beam is radiated.

The light beam having passed the above power density control mechanism is preferable, for the following reason. That is, when the light beam is radiated on the optical information recording medium, the reference beam region thereof forms a random pattern produced by differences in power density, whereby interference between the information beam and the reference beam can be rendered favorable. Generally, the pattern is produced by use of a spatial light modulator; however, this function can be provided by the power density control mechanism. In this case, a spatial light modulator is required only for the central section. Accordingly, driving speed of the spatial light modulator can be increased and energy savings can be achieved.

The power density control mechanism is preferably set such that the transmittance with respect to the light beam at a portion where the central section of the light beam is radiated is lower than that at a portion where the peripheral section of the light beam is radiated, by a ratio falling within a range of 10 to 60%. When the reduction ratio is greater than or equal to 10%, an increase in information capacity per page can be secured; and when the same is smaller than or equal to 60%, prolonging of recording time per page, which is a problem arising from a reduction in power density, can be suppressed.

In particular, when a laser light source whose output power falls within a range of about 5 to 50 mW, such as a semiconductor laser, is employed, the transmittance with respect to the light beam at a portion where the central section of the light beam is radiated is preferably set lower than that at a portion where the peripheral section of the light beam is radiated, by a ratio falling within a range of 10 to 50%. When the reduction ratio is greater than or equal to 10%, an increase in information capacity per page can be secured; and when the same is smaller than or equal to 50%, prolonging of recording time per page arising from a drop in power density can be suppressed.

Meanwhile, for comparison of transmittance, mean values in the respective portions are to be employed.

In addition, it is not preferred to actively decrease the transmittance at the portion where the peripheral section of the light beam is radiated with a view toward securing a difference between the power density in the portion where the central section of the light beam is radiated and that in the portion where the peripheral section of the same is radiated. Transmittance in the peripheral section of the light beam is preferably 95% or greater, more preferably 95% to 99%.

The reflectance-type power density control mechanism is analogous to the transmittance-type power density control mechanism, except that in the above description “transmittance” is to be replaced with “reflectance.”

Hereinbelow, specific examples of the power density control mechanism will be described.

Examples of the transmittance-type power density control mechanism include a cover glass formed on a surface of a spatial light modulator, and a liquid crystal panel which can adjust transmittance by changing a voltage to be applied. The liquid crystal panel also serves as a spatial light modulator. Examples of the reflectance-type power density control mechanism include a mirror disposed upstream of the optical information recording medium, and a DMD (digital mirror device) including pixels configured by mirrors whose reflectances are adjustable. The DMD also serves as a spatial light modulator.

For adjusting transmittance through the cover glass, there is employed a method of, for instance, subjecting a glass substrate to sputtering, deposition, coating, and the like, to thus affix a light-absorbing material thereon. Meanwhile, the light-absorbing material is preferably resistant to deterioration. A preferred material for the cover glass is uniform and does not to disturb a wave surface of light. So long as a visible light is employed as the laser light source, a synthetic glass may be used; however, when an ultraviolet light is employed as the laser light source, fused quartz is preferable. Meanwhile, the cover glass maybe disposed either upstream or downstream of the spatial light modulator on the optical path.

The liquid crystal panel employed as the spatial light modulator and also as the power density control mechanism is characterized in that transmittance at the portion where the central section of the light beam is radiated is low as compared that at the portion where the peripheral section of the same is radiated. For adjusting transmittance through the liquid crystal panel, there is employed a method of, for instance, changing orientations of liquid crystal molecules by changing a voltage to be applied.

The mirror is disposed upstream of the optical information recording medium. For adjusting the reflectance of the mirror, there is employed a method of, for instance, changing a condition of a sputtering process, that of a CMP (chemical mechanical polishing) oxidization process, or the like, employed informing a mirror metal. For reducing the reflectance, the following methods are employed. That is, in the sputtering process for forming the mirror metal, a deposition amount of the mirror metal is reduced; and in the CMP oxidization process, a degree of oxidization is decreased.

The DMD employed as the spatial light modulator and also as the power density control mechanism adjusts reflectance of each of the mirrors, thereby adjusting the power density. For adjusting reflectance of each mirror, methods similar with those employed in the above-mentioned mirror are employed during the course of manufacturing the DMD.

(2) Spatial Light Modulator

The spatial light modulator is disposed on the optical path of the light beam, and which can spatially modulate the light beam. The spatial light modulator has pixels that are arranged in a two-dimensional array at a portion where the central section of the light beam is radiated. By means of passing through the spatial light modulator, the light beam is rendered such that the central section of the light beam is employed as the information beam region and the peripheral section of the same is employed as the reference beam region. Meanwhile, “to spatially modulate” referred to here means to modulate the light beam in terms of amplitude, phase, polarization, or the like.

Pixels disposed in the portion where the central section of the light beam is radiated are, generally, arrayed in two-dimensional gratings, and contain digital data sets to be recorded in the optical information recording medium. The number of digital data sets contained in these pixels corresponds to information capacity per page; in other words, corresponds to an amount of information that can be recorded in the optical information recording medium by a single radiation operation.

In the case of the transmittance-type spatial light modulator, on the portion where the peripheral section of the light beam is radiated, a random pattern produced by variations in transmittance of light beams may be formed; and in the case of the reflectance-type spatial light modulator, a random pattern produced by variation in reflectance of light beams may be formed. Meanwhile, when a random pattern produced by variation in transmittance of light beams is formed in the portion where the peripheral section is radiated in the power density control mechanism, formation of such a random pattern in the spatial light modulator is not necessary.

Examples of the transmittance-type spatial light modulator include a transmittance-type liquid crystal panel, and the like; and examples of the reflectance-type spatial light modulator include a reflectance-type liquid crystal panel, a DMD, and the like.

The transmittance-type liquid crystal panel can deflect liquid crystal molecules for each pixel. The transmittance-type liquid crystal panel adjusts transmittance of light beams by use of the polarization of the liquid crystal molecules.

The reflectance-type liquid crystal panel is analogous with the transmittance-type liquid crystal panel, except that light beams travels back and forth within the liquid crystal panel.

The DMD can adjust orientations of reflection in two directions with use of mirrors provided for each pixel. The DMD produces two conditions, constituted of bright and dark, through varying reflection directions of the mirrors. The mirror rotates about a hinge by means of electrostatic attraction between the mirror, and a memory cell provided below the mirror. Generally, rotation of the mirror is suppressed to about ±10° by means of a mechanical stopper.

The spatial light modulator of the embodiments may be “Liquid Crystal Silicon (hereinafter, referred to as “LCOS”)”. “LCOS” has pixels configured by a mirror whose reflectance is adjustable. “LCOS” is a device combined with LCD and DMD. In DMD, a light reflects on a small mirror. In “LCOS” the LCD has a same function as the mirror of the DMD. An optical modulation can be performed by controlling a reflection of the light according to the switching ON/OFF of the LCD. In “LCOS”, each LCD pixel is located on the mirror. Compared with the transmittance-type liquid crystal panel, further information can be included in the information beam region, since the pixel does not become small due to a wiring space etc. The modulation method of the power density by using “LCOS” as the spatial light modulator is the same way when DMD is used as the spatial light modulator. Thus, one is a method of modulating a transmittance ration of the cover glass, and the other one is a method of modulating a reflectance ration of the mirror.

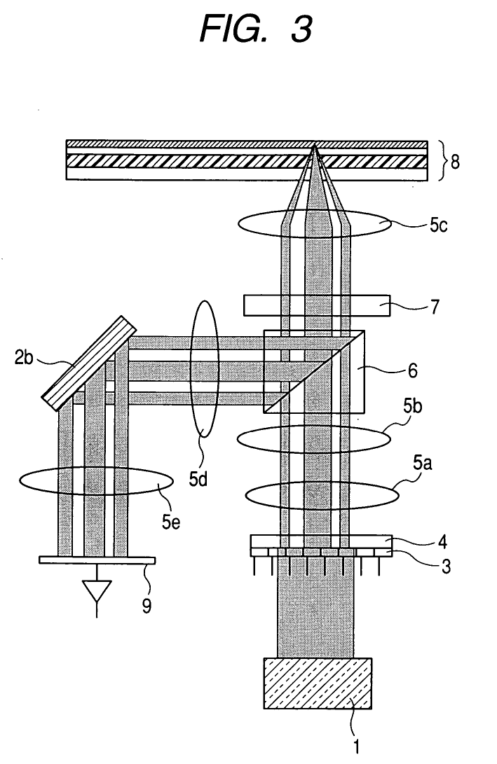

FIG. 3 is a schematic view for explaining an example where the optical information recording apparatus of the second embodiment employs the transmittance-type spatial light modulator.

As shown in FIG. 3, the example is analogous to that shown in FIG. 2, except that the light beam and the like are disposed so as to pass through the spatial light modulator 3.

(3) Interference Fringe Formation Mechanism

The interference fringe formation mechanism is disposed on the optical path of the light beam, and has a function of causing interference between the reference beams and the information beams on the optical path, downstream of the spatial light modulator and the power density control mechanism.

More specifically, examples of the interference fringe formation mechanism include a quarter-waveplate, and an imaging lens.

(4) Photodetector

The photodetector is disposed at the terminal end of the optical path of the information beam, and has a function of detecting light beams when information is reproduced.

(5) Laser Light Source

Examples of the laser light source include gas lasers, such as a semiconductor laser, an He—Ne laser, and an Ar laser; and solid lasers, such as a YAG (LD-pumped Nd: YAG laser (Nd³+:Y₃AL₅O₁₂)) laser.

When interference fringes are formed by means of an optical path difference between the recording beam and the reference beam, a light beam whose coherence length is longer than the optical path difference is employed. For consumer use, the optical path difference is assumed to be 1 mm or longer, and the coherence length is preferably about 1 mm or longer. Meanwhile, as required, the light beam may be subjected to feedback to lengthen the coherence length.

(6) Others

The optical information recording apparatus includes, in addition to the above-mentioned pickup system, a drive mechanism, a control mechanism, and the like.

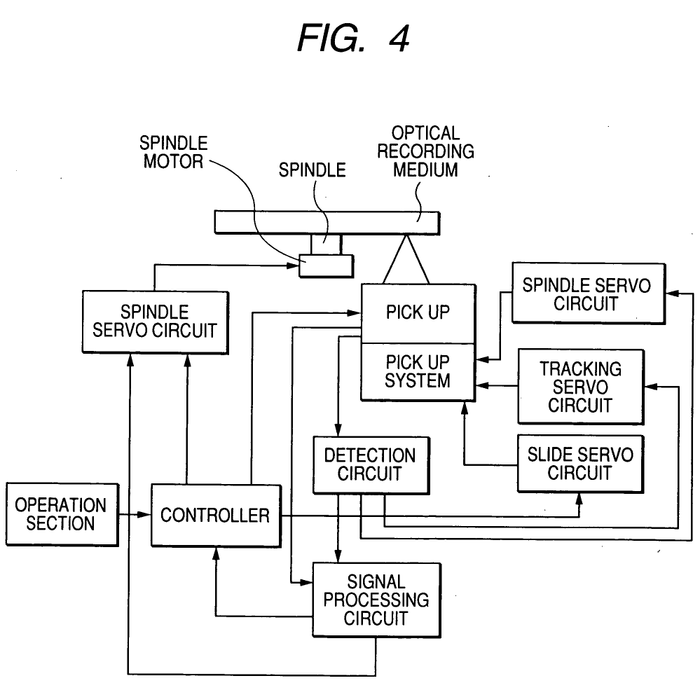

FIG. 4 is a schematic view for explaining a driving mechanism, a control mechanism, and the like of the optical information recording apparatus. Meanwhile, for convenience of explanation, a case where an optical information recording medium assume the form of a disk will be described.

As shown in FIG. 4, the optical information recording medium is attached to a predetermined location by means of a spindle. The spindle is rotated by a spindle motor. A spindle servo circuit controls the rotation speed of the spindle motor.

The above-mentioned laser light source, spatial light modulator, power density control mechanism, interference fringe formation mechanism, and photodetector are collectively called a pickup system. Mechanisms constituting the pickup system are driven by a pickup drive device, as required.

A detection circuit detects electric signals converted by the photodetector in the pickup system. Examples of the electric signals include a focus error signal (hereinafter referred to as an “FE signal”), a tracking error signal (hereinafter referred to as a “TE signal”), a reproducing signal (hereinafter referred to as an “RF signal”), and recording data of the optical information recording medium.

A focus servo circuit performs a focus servo operation in accordance with the FE signal, by means of moving the imaging lens vertically with respect to a plane of the optical information recording medium. A tracking servo circuit performs a tracking servo in accordance with the TE signal, by means of moving an object lens in the radial direction of the optical information recording medium. A slide servo circuit performs a slide servo operation in accordance with the TE signal and an instruction from a controller, which will be described later, to move the pickup system in the radial direction of the optical information recording medium.

A signal processing circuit decodes and reproduces recorded data in the optical information recording medium, reproduces a reference clock signal in accordance with the RF signal, and discriminates an address signal of the optical information recording medium.

The controller controls the entire optical information recording apparatus. The controller inputs the reference clock signal, the address data, and the like, which are output from the signal processing circuit. The controller also controls the pickup system, the spindle servo circuit, the slide servo circuit, and the like. An operation section provides a variety of instructions to the controller. For instance, the controller inputs the reference clock signal to the spindle servo circuit.

The controller has a CPU (central processing unit), ROM (read only memory), and RAM (random access memory). The CPU executes a program stored in the ROM while using the RAM as a working space.

### EXAMPLES

Examples will be described hereinbelow; however, the present invention is not limited to the examples described hereinbelow; other configurations may be employed, so long as they fall within the scope of the spirit of the invention.

Examples 1 and 2 and Comparative Examples 1 and 2 were performed, whereby recording characteristics were evaluated while different kinds of the power density control mechanism were employed.

### Example 1

An optical information recording apparatus configured as shown in FIG. 3 was used.

As a laser light source, a semiconductor laser having a wavelength at 407 nm and an output power of 30 mW was employed. As a spatial light modulator, a transmittance-type liquid crystal spatial light modulator was used. A radius of a light beam passing through the transmittance-type spatial light modulator was expanded to 2.5 mm. A region within 2 mm from the center of the light beam was employed as an information beam region, and a region where a distance from the same falls within 2 to 2.5 mm was employed as a reference beam region. At this time, the area of the information beam region was about 1.7 times as large as that of the reference signal region, and the information beam region contained data of 50 kilobits.

As a power density control mechanism, a cover glass disposed on an incident surface of the transmittance-type liquid crystal spatial light modulator was used. Transmittance of the cover glass with respect to a recording beam of 407 nm wavelength was 60% at the center of the light beam, and 99% at a portion 2 mm from the center of the light beam. Transmittance gradually varied from the center of the light beam to the periphery.

The optical information recording medium was manufactured as follows.

First, a transparent substrate made of polycarbonate of a disk shape of 12 cm in diameter and 600 μm in thickness and having grooves on one side was prepared. A reflection film of AgNdCu and of 200 nm thickness was formed on the groove-side surface of the transparent substrate by means of sputtering. Furthermore, on the reflection film, a transparent film made of SiO₂ and 100 nm in thickness was formed by means of sputtering. On the other surface of the transparent substrate, a shrouding spacer consisting of a sheet made of Teflon (registered trademark) was formed. In the shrouding, a photopolymer was cast, and another transparent substrate was placed thereon. Thereafter, by means of storage for 24 hours in a light-shielded environment and at a temperature (25C), an optical information recording medium having a recording layer of 200 pm thickness was obtained.

The photopolymer was manufactured as follows.

A polymer matrix precursor solution was obtained by means of mixing 15.1 g of 1,6-Hexanediol diglycidyl ether (epoxy equivalent 151, manufactured by Nagase ChemteX Corporation) serving as a diglycidyl ether; and 3.38 g of diethylenetriamine serving as an amine. Meanwhile, a monomer solution was prepared by means of mixing 1.546 g of N-vinyl carbazole serving as a radical polymerization chemical, 0.891 g of N-vinyl pyrolidone serving as a radical polymerization chemical, and 0.056 g of Irgacure 784 (manufactured by Chiba Specialty Chemicals Co., Ltd), and 0.011 g of Perbutyl H (manufactured by NOF Corporation) serving as photoradical polymerization initiators.

Eight g of the polymer matrix precursor solution and 2 g of the monomer solution were mixed and degassed, thereby obtaining the photopolymer.

A recording and reproduction test was performed, whereby a bit error rate was measured.

The diameter of the light beam on an upper surface of the recording layer of the optical information recording medium was 1,200 μm, and that on the lower surface of the recording layer was 900 μm. In accordance with a CLV (constant linear velocity) method, different sets of data were recorded on each page in accordance with shift multiplexing. Further, the recorded data was reproduced by means of a light beam whose power had been reduced to 1/10.

As a result, the bit error rate was found to be on the order of 10⁻⁵.

### Comparative Example 1

A test similar to that in Example 1 was performed, except that a cover glass whose transmittance of the recording beam was uniform on the entire face, at 99%, was used in place of the cover glass employed as the power density control mechanism.

As a result, the bit error rate was found to be on the order of 10⁻¹.

Meanwhile, in order to attain the bit error rate on the order of 10⁻⁵, the information beam region must be made from a region within a 0.5 mm radius from the center of the light beam. At this time, the capacity of information per page was 3 kilo bits.

### Example 2

A test similar to that in Example 1 was performed, except for the following. That is, a DMD was employed in place of the transmittance-type liquid crystal spatial modulator; the configuration of the entire optical information recording apparatus was rendered similar to that of FIG. 4; and the transmittance through the cover glass was 80% at the center of the light beam, and 99% at a portion 2 mm from the center of the light beam. Meanwhile, since the DMD is a reflectance-type spatial light modulator, the recorded light passed through the cover glass twice.

As a result, the bit error rate was found to be on the order of 10⁻⁵.

### Comparative Example 2

A test similar to that in Example 2 was performed, except that a cover glass whose transmittance of the recording beam was uniform on the entire face, at 99%, was employed in place of the cover glass employed as the power density control mechanism.

As a result, the bit error rate was found to be on the order of 10⁻¹.

Meanwhile, in order to attain the bit error rate on the order of 10⁻⁵, the information beam region must be formed in a region within a 0.5 mm radius from the center of the light beam. At this time, the capacity of information per page was 3 kilo bits.

Example 1 and 2 and Comparative Examples 1 and 2 show that the power density control mechanism of the embodiment can maintain the bit error rate and increase the information capacity per page. Accordingly, the optical information recording apparatus and the method therefor of the invention can maintain visibility and increase information capacity per page.

Hithertofore, embodiments of the invention have been described; however, the invention is not limited thereto, and can be modified in various ways within the scope of the invention as set forth in the appended claims. Also, when being practiced, the invention can be modified in various manners without departing from the scope of the invention. Furthermore, by means of appropriately combining a plurality of components disclosed in the above embodiments, a variety of inventions can be formed.

What is claimed is:

1. An optical information recording apparatus comprising:
a laser light source radiating a light beam;
a spatial light modulator spatially modulatable the light beam, the spatial light modulator disposed on an optical path of the light beam, and the spatial modulator having pixels arranged in a two-dimensional array at a portion where a central section of the light beam is radiated;
a power density control mechanism disposed on the optical path of the light beam and whose transmittance with respect to the light beam at a portion where the central section of the light beam is radiated is set lower than that at a portion where a peripheral section of the light beam is radiated; and
an interference fringe formation mechanism forming interference fringes from the central section of the light beam and the peripheral section of the light beam on an optical information recording medium disposed downstream on the optical path of the light beam.

2. The optical information recording apparatus according to claim 1, wherein the power density control mechanism has, at a portion where the peripheral section of the light beam is radiated, a random pattern produced by differences in transmittance with respect to the light beam.

3. The optical information recording apparatus according to claim 1, wherein the power density control mechanism is set such that a transmittance with respect to the light beam at a portion where the central section of the light beam is radiated is lower than that at a portion where the peripheral section of the light beam is radiated, by a ratio falling within a range of 10 to 60%.

4. An optical information recording apparatus comprising:
a laser light source radiating a light beam;
a spatial light modulator spatially modulatable the light beam, the spatial light modulator disposed on an optical path of the light beam, and the spatial light modulator having pixels arranged in a two-dimensional array at a portion where a central section of the light beam is radiated;
a power density control mechanism disposed on the optical path of the light beam and whose reflectance with respect to the light beam at a portion where the central section of the light beam is radiated is set lower than that at a portion where a peripheral section of the light beam is radiated; and
an interference fringe formation mechanism forming interference fringes from the peripheral section of the light beam and the peripheral section of the light beam on an optical information recording medium disposed downstream on the optical path of the light beam.

5. The optical information recording apparatus according to claim 4, wherein the power density control mechanism has a random pattern produced by differences in reflectance with respect to the light beam at a portion where the peripheral section of the light beam is radiated.

6. The optical information recording apparatus according to claim 4, wherein the power density control mechanism is set such that the reflectance with respect to the light beam at a portion where the central section of the light beam is radiated is lower than the reflectance at a portion where the peripheral section of the light beam is radiated, by a ratio falling within a range of 10 to 60%.

7. A method of recording optical information comprising:
spatially modulating a central section of a light beam to thus cause an information beam to contain data to be recorded;
decreasing power density in a central section of the light beam to a greater extent in relation to a decrease in power density in a peripheral section of the light beam; and
forming interference fringes from the peripheral section of the light beam and the central section of the light beam on the optical recording medium.

8. The method for recording optical information according to claim 7, wherein a reduction ratio of the power density in the peripheral section of the light beam is lower than a reduction ratio in the central section of the light beam, by a ratio falling within a range of 10 to 60%.

9. An optical information recording apparatus comprising:
a laser light source radiating a light beam;
a member disposed on an optical path of the light beam, and integrally configured by a spatial light modulator spatially modulatable the light beam and a power density control mechanism; and
an interference fringe formation mechanism forming interference fringes from the central section of the light beam and the peripheral section of the light beam on an optical information recording medium disposed downstream on the optical path of the light beam, wherein the spatial light modulator has pixels arranged in a two-dimensional array at a portion where a central section of the light beam is radiated, and
wherein a transmittance of the power density control mechanism with respect to the light beam at a portion where the central section of the light beam is radiated is set lower than that at a portion where a peripheral section of the light beam is radiated.

10. The optical information recording apparatus according to claim 9, wherein the power density control mechanism has, at a portion where the peripheral section of the light beam is radiated, a random pattern produced by differences in transmittance with respect to the light beam.

11. The optical information recording apparatus according to claim 9, wherein the power density control mechanism is set such that a transmittance with respect to the light beam at a portion where the central section of the light beam is radiated is lower than that at a portion where the peripheral section of the light beam is radiated, by a ratio falling within a range of 10 to 60%.

12. The optical information recording apparatus according to claim 9, wherein the member is a transmittance-type liquid crystal panel having pixels whose transmittance is adjustable.

13. An optical information recording apparatus comprising:
a laser light source radiating a light beam;
a member disposed on an optical path of the light beam, and integrally configured by a spatial light modulator spatially modulatable the light beam and a power density control mechanism; and
an interference fringe formation mechanism forming interference fringes from the peripheral section of the light beam and the peripheral section of the light beam on an optical information recording medium disposed downstream on the optical path of the light beam, wherein the spatial light modulator has pixels arranged in a two-dimensional array at a portion where a central section of the light beam is radiated, and
wherein a reflectance of the power density control mechanism with respect to the light beam at a portion where the central section of the light beam is radiated is set lower than that at a portion where a peripheral section of the light beam is radiated.

14. The optical information recording apparatus according to claim 13, wherein the power density control mechanism has a random pattern produced by differences in reflectance with respect to the light beam at a portion where the peripheral section of the light beam is radiated.

15. The optical information recording apparatus according to claim 13, wherein the power density control mechanism is set such that the reflectance with respect to the light beam at a portion where the central section of the light beam is radiated is lower than the reflectance at a portion where the peripheral section of the light beam is radiated, by a ratio falling within a range of 10 to 60%.

16. The optical information recording apparatus according to claim 13, wherein the member is a reflectance-type liquid crystal panel having pixels whose transmittance is adjustable.

17. The optical information recording apparatus according to claim 1, wherein the power density control mechanism is a cover glass whose transmittance is adjustable.

18. The optical information recording apparatus according to claim 4, wherein the power density control mechanism is a mirror.

19. The optical information recording apparatus according to claim 13, wherein the member is a digital mirror device having a mirror whose reflectance is adjustable.

20. The optical information recording apparatus according to claim 13, wherein the member is a liquid crystal on silicon having a mirror whose reflectance is adjustable.
